(19) United States
(12) Patent Application Publication
(10) Pub. No.: US 2013/0129961 A1
(43) Pub. Date: May 23, 2013

(54) Method for producing crystal decoration elements

(71) Applicants: Stefan POINTNER, Schwaz (AT); Nicola WINKLER, Buch (AT)

(72) Inventors: Stefan POINTNER, Schwaz (AT); Nicola WINKLER, Buch (AT)

(21) Appl. No.: 13/661,187

(22) Filed: Oct. 26, 2012

(30) Foreign Application Priority Data
Oct. 31, 2011 (AT) A 1597/2011

(51) Int. Cl. B44C 5/00; B44F 5/00

(52) U.S. Cl. CPC B44C 5/00; B44F 5/00
USPC 428/67; 156/280

(57) ABSTRACT

A method is proposed for producing a composite material plate (2) equipped with decorative elements (1). To provide advantageous conditions, firstly a carrier plate (3) is equipped with a resin layer (4), after which the decorative elements (1) arranged on a support layer (5) are immersed with the support layer (5) by a desired amount (h) into the resin layer (4), and the support layer (5), in particular a carrier film, and optionally the carrier plate (3) are detached after curing of the resin layer (4) from the decorative elements (1), which are held in the now cured resin layer (4).

The invention relates to a method for producing a composite material plate equipped with decorative elements and a composite material plate produced according to this method.

Such a known composite material plate (AT 502 307 B1) is formed in three layers, for example, and has at least one cover layer made of glass, an intermediate layer made of artificial resin, in which the decorative material is embedded, and a carrier plate. The decorative material consists of one or more particles embedded in the intermediate layer, for example, made of glass crystals or the like, which are supported by a network, which is glued onto the carrier plate. For the production, a double-sided adhesive film is applied to the bottom side of a network occupied with discrete particles and the network is glued onto the carrier plate, after which a liquid artificial resin is applied to the discrete particles and the network, and a cover glass pane is put on. Finally, the edges are sealed and subsequently the plastic resin is cured. The decorative material is therefore embedded between carrier and cover plate in the artificial resin. If gemstones are used as the decorative materials, which are embedded in an ornamental manner in the filler layer, for example, these gemstones lose a substantial component of their optical effects, since the index of refraction values of the gemstones and the artificial resin in which they are embedded are very close to one another.

To substantially maintain or possibly even amplify the optical effects of decorative material, it has already been proposed (DE 40 08 556 C1) that decorative material be arranged on a carrier plate and a cover plate be provided with spacing in front of the carrier plate, to protect the decorative material from direct access. A decorative panel having a glass plate was especially proposed, on which a plurality of rhinestones is fixed in an ornamental arrangement, the decorative panel comprising a semi-transparent mirror plate, the carrier plate having glass stones arranged with spacing therefrom, and a fully mirrored plate in turn situated therefrom. Using such a composite material plate, good optical effects may be achieved, however, it is mechanically less stable than the composite material plate known from AT 502 307 B1 because of the glass panes arranged with spacing to one another. Such composite material plates are typically used as decorative panels, for example, for wall coverings, tabletops, doors, partition walls, or the like, an increased demand naturally being placed on the breaking strength or the operational safety for such intended uses.

A method for producing decorative elements is known, for example, from WO 2006/074860. Described in simplified form, according to this method, firstly a rubber material is poured into a casting mold, whereupon decoration elements are laid in the not yet cured rubber, the decoration element height being greater than the rubber layer thickness. The decoration elements rest on the casting mold. After at least partial curing of the rubber layer, further decoration elements can be scattered on, before a resin layer is poured over decoration elements and rubber layer. After curing of rubber layer and resin layer, they are removed from the casting mold and the rubber layer can be drawn off of the resin layer. A decoration element is therefore to be provided, from whose surface the decorative parts protrude like a relief. At least one rubber layer and at least one resin layer are therefore always to be provided, which results in an increased production expenditure.

A further method for producing injection-molded decoration articles is known from AT 507 883 A4. To be able to provide injection-molded elements having decorative elements arranged in the injection-molded elements, it is proposed that the decorative elements be applied to a carrier film and the carrier film having the decorative elements then be inserted in an injection mold and the decorative elements be extrusion coated, which, according to the method, practically only allows complete extrusion coating (except for the adhesive surface) in the injection-molding machine, however.

Furthermore, casting decorative elements in a resin layer in such a manner is known (AT 6729U1), firstly a base layer being manufactured, this being permitted to at least partially cure, before decorative objects, in particular plant parts, are pressed into the surface of this layer and thus regionally affixed. Liquid casting resin is then poured over the decorative objects, so that the free plant parts float up and assume a spatial design. Subsequently, still a further surface layer can be poured over these resin layers.

Proceeding from prior art of the above-described type, the invention is therefore based on the object of providing a composite material plate, which achieves the best possible optical effects with a high breaking strength and allows a broad spectrum of possible optical effects.

The invention achieves this object in that firstly a carrier plate is equipped with a resin layer, after which the decorative elements arranged on a support layer are immersed with the support layer to a desired extent into the resin layer, and the support layer, in particular a carrier film, and optionally the carrier plate are detached from the decorative elements, which are now held in the cured resin layer, after curing of the resin layer.

The method according to the invention is distinguished in that firstly in a mold, whose base is the carrier plate made of material to which adhesive does not adhere or to which adhesive does adhere, for example, a transparent or colored two-component epoxy artificial resin is poured up to a precisely defined height. In this artificial resin layer, the support layer, which was previously produced manually or by machine and provided with the decorative elements (for example, glass crystals), in particular a one-sided self-adhesive carrier film, is laid with the decorative elements in front into the resin layer up to a precisely defined height. The resin subsequently cures.

This layer made of resin and decorative elements can be used further in various embodiments, both with a cover layer made of glass, transparent plastic, a cover layer made of transparent artificial resin or other cover materials, or without a further cover layer. Through this embodiment, it is possible to integrate particulate inclusions in the artificial resin layer, in particular glass crystals in various colors, sizes, and shapes, comprehensively, in corresponding motif shapes, sizes, and types independently, dimensionally accurately and precisely fitted up to a freely defined fixed dimension of height. In composite plates produced according to this method, at least a part of the layer of the decorative elements, preferably crystals, are exposed on top and the crystals or the decorative elements are visible in a structurally exposed manner.

Particularly robust conditions result if the resin layer or the support plate is provided with a further resin layer, which optionally completely covers the decorative elements. A transparent artificial resin layer consisting of the same material or consisting of another comparable material is flatly poured onto the already produced crystal decoration element layer or the already produced motif. It is additionally possible to define the height or the spacing between the carrier plate and the cover plate covering it by an adhesive tape or similar material fastened on the outer edge of the crystal decoration element layer. For this purpose, the carrier plate can be equipped on the edge with a frame-shaped spacer (e.g., self-adhesive aluminum tape, silicone tape, or the like), on which the cover plate is arranged resting.

In addition, a silicone cord or another sealing spacer material can be laid as a seal toward the edge on the already produced crystal decoration element layer or on the already produced motif, and a light-transparent cover glass pane or transparent plastic pane can be put on, which are then laid together in a (wooden) composite frame and closed by means of screws. Artificial resin can then be poured into the gap space thus resulting between the cover glass pane and the finished decorative layer if desired. This layer overlaps the discrete particles, cures, and essentially forms a two-layered composite material.

According to a further alternative, the already produced decorative layer or the already produced motif is coated using a transparent liquid artificial resin, clear lacquer, or similar transparent material, so that a thin layer is formed over the discrete particles, preferably glass crystals, and it then acts to be considered as an additional protective layer.

To achieve special optical effects, an illuminant arranged on a support structure can be provided, whose wiring is embedded in a resin layer.

Composite material plates equipped with decorative elements can consist of the following materials, for example. The transparent cover plate can consist of silicate glass, plastic, frosted glass, sandblasted glass, fire-polished glass, toughened glass, composite glass, or acid-polished glass. For example, glass pieces, polished and unpolished glass crystals, wood, plastics, stones, images and paper, paint layers, gold and gold dust or such particles, colored and noble metals in various forms, sizes, and types can be provided as the decorative material. In addition, lights, for example, LEDs, can be embedded in the resin as decorative materials.

A composite plate having decoration elements according to the invention, which can also be combined among one another and with one another in an arbitrary manner, is used in particular to decorate objects, e.g., shower partition walls, bar coverings, bar tops, countertops, various furniture plates, flagstones, natural/artificial stone floors and plates, room dividers, disco floors, edgings and tiles, living accessories, glass furniture and the parts thereof, façade parts and façade elements, and the like. Separate tiles, edgings, inlaid parts in furniture, inlaid parts in stones, stickers in the advertising and automobile industry, etc., can also be generated, which are used outside and in humid regions and in interiors.

The invention is schematically shown on the basis of an exemplary embodiment in the drawing. In the figures

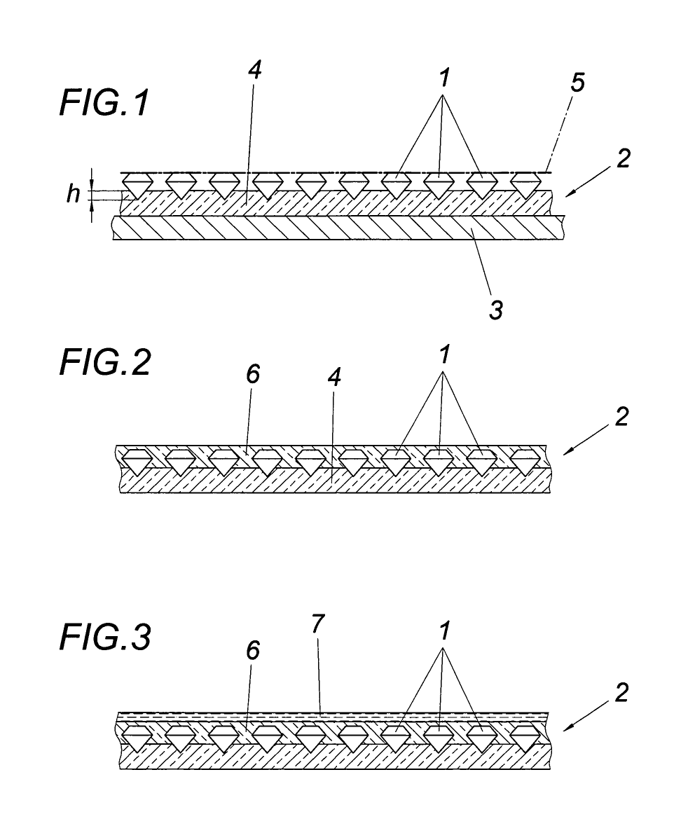

FIGS. 1 to 5 show various exemplary embodiments of composite plates produced as per a method according to the invention in cross-section.

A composite material plate 2, which is produced as per a method according to the invention and equipped with decorative elements 1, comprises a carrier plate 3, which is equipped with a resin layer 4. The carrier plate consists of a material to which adhesive does not adhere or a material to which adhesive does adhere, depending on whether the resin layer 4 is to form a composite with the carrier plate 3 or is to be detachable later after curing. Subsequently, the decorative elements 1 arranged on a support layer 5, in particular a carrier film, are immersed with the support layer 5 by a desired amount h into the resin layer 4 and left in the desired location until curing of the resin. After curing of the resin, the support layer 5 and optionally the carrier plate 3 are detached from the now cured resin layer and the decorative elements 1 held thereby. FIG. 1 shows such a material composite made of resin layer 4 and decorative elements 1, having the carrier plate made of material to which adhesive does not adhere or material to which adhesive does adhere.

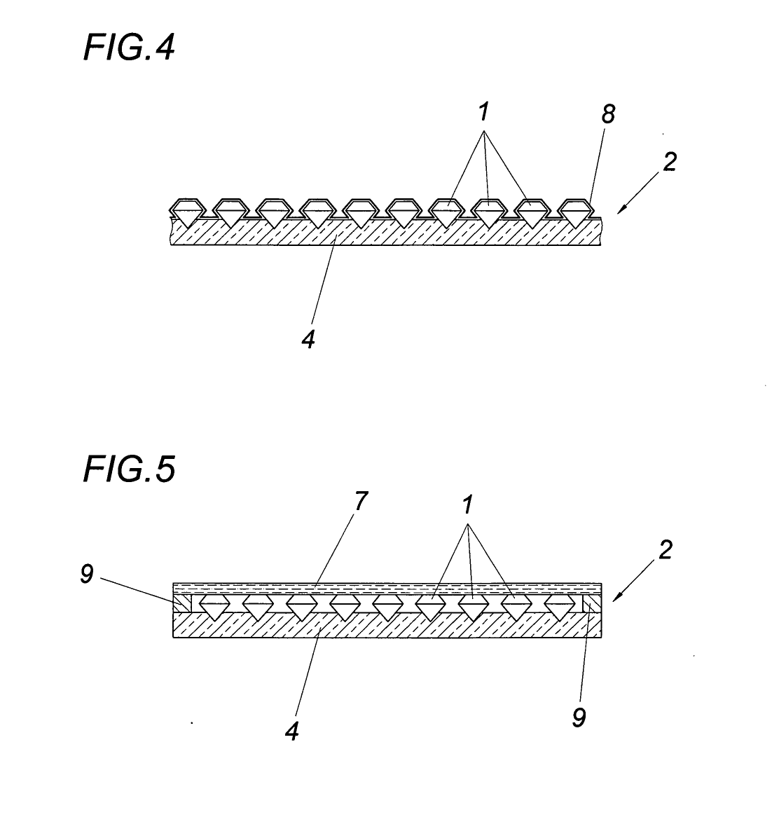

In the exemplary embodiment according to FIG. 2, the resin layer 4 is equipped with a further resin layer 6, which completely covers the decorative elements 5. In the exemplary embodiment according to FIG. 3, the resin layer 4 is additionally or alternatively covered with a cover plate 7 and in the exemplary embodiment according to FIG. 4, the decorative elements 1 and the resin layer 4 are coated with a thin protective film 8, in particular a resin film.

In the exemplary embodiment according to FIG. 5, the resin layer 4 is equipped on the edge with a frame-shaped spacer 9 and the cover plate 7 rests on the spacer 9.

The choice of additional cover layers and meaningful combinations of the above-mentioned examples are left to a person skilled in the art.

1. A method for producing a composite material plate equipped with decorative elements, wherein firstly a carrier plate is equipped with a resin layer, after which the decorative elements arranged on a support layer are immersed with the support layer by a desired amount into the resin layer, and the support layer, in particular a carrier film, and optionally the carrier plate are detached after curing of the resin layer from the decorative elements, which are held in the now cured resin layer.

2. The method according to claim 1, wherein the resin layer is equipped with a further resin layer which optionally completely covers the decorative elements.

3. The method according to claim 1, wherein the resin layer is covered with a cover plate.

4. The method according to claim 3, wherein the resin layer is equipped on the edge with a frame-shaped spacer, and the cover plate is arranged resting on the spacer.

5. The method according to claim 1, wherein the decorative elements and preferably the resin layer are coated with a thin protective film, in particular a resin film.

6. The method according to claim 1, wherein at least parts of the decorative elements are illuminants arranged on a support structure, whose wiring is embedded in a resin layer.

7. A composite material plate equipped with decorative elements according to claim 1.

8. The composite material plate according to claim 7, wherein the transparent cover plate consists of silicate glass, plastic, frosted glass, sandblasted glass, fire-polished glass, toughened glass, composite glass, or acid-polished glass.

9. The composite material plate according to claim 7, wherein glass pieces, polished and unpolished glass crystals, wood, plastics, stones, images and papers, paint layers, gold and gold dust or such particles, colored and noble metals in various forms, sizes, and types are provided as the decorative materials.

10. The composite material plate according to claim 7, wherein lights, for example, LEDs, are embedded in the resin as decorative materials.
